(19) United States
(12) Patent Application Publication
(10) Pub. No.: US 2022/0408726 A1
(43) Pub. Date: Dec. 29, 2022

(54) NO-RINSE FRESHENING COMPOSITIONS FOR TREATING INANIMATE SURFACES

(71) Applicant: The Procter & Gamble Company, Cincinnati, OH (US)

(72) Inventors: Katherine Ann STRASEMEIER, Cincinnati, OH (US); Yoshiki ISHIDA, Singapore (SG); Atsuko KONISHI, Kobe (JP)

(21) Appl. No.: 17/841,729

(22) Filed: Jun. 16, 2022

Related U.S. Application Data
(60) Provisional application No. 63/213,755, filed on Jun. 23, 2021.

(51) Int. Cl. A01N 33/12; A01N 37/36; A01N 37/04; A01P 1/00

(52) U.S. Cl. CPC A01N 33/12; A01N 37/36; A01N 37/04; A01P 1/00

(57) ABSTRACT

A no-rinse freshening composition for treating an inanimate surface or article is described. The freshening composition includes: at least 85% by weight of the freshening composition of water; a carboxylic acid; a salt of citric acid; and a mixture of first and second antimicrobial agents, wherein each of the first and second antimicrobial agents is according to Formula (I). The composition has a neat pH of from 3 to 6 at room temperature and a weight ratio of the total amount of the carboxylic acid and the salt of citric acid to the mixture of the first and second antimicrobial agents is from 1:1 to 10:1.

### FIELD OF THE INVENTION

The present invention relates to no-rinse freshening compositions having a carboxylic acid, salt of citric acid, and at least one quaternary ammonium compound in an aqueous carrier for treating inanimate surfaces.

### BACKGROUND OF THE INVENTION

Presence of microorganisms of human health concern and their metabolites on surfaces in an interior environment, clothing and/or on skin can lead to health risks including but not limited to exacerbating eczema, skin irritations, influenza, spread of respiratory and gastrointestinal infections and diseases. Some of the health risks are caused by bacteria infections and/or virus infections.

A type of microorganism of human health concern are viruses which are acellular microorganisms and may be classified as enveloped viruses having an envelope represented by influenza virus and non-enveloped viruses like human norovirus. Human norovirus is a dominant cause of acute gastroenteritis around the world. Diseases caused by non-enveloped virus are also common in our daily life and often such diseases are spread from patients to healthy people via inanimate hard and soft surfaces.

In particular, people can get infected by the viruses through inhalation of droplets from coughing and sneezing of an infected person, or though contact with inanimate surfaces having the droplets. For example, the droplets containing the virus may deposit on surfaces such as carpet fabric, vehicle seat upholstery or the like and such surfaces having the virus containing droplets become a secondary virus source. The virus containing droplets may also deposit on wall surfaces, such as walls comprising wallpaper, to create additional or alternative secondary microorganism sources.

The above described secondary microorganism sources can create a cycle of transmission of infections in an interior space, and may facilitate transmission of infections outside of the interior space. Household antimicrobial compositions have been developed to treat surfaces in view of the above problems but such compositions are generally directed towards a single antiviral effect for reducing enveloped virus infectivity. This is because antimicrobial actives such as chlorine bleach, alcohol, quaternary ammonium compounds used to make such products to be efficacious against both enveloped and non-enveloped virus have disadvantages such as like leaving residue and/or stains on household surfaces if used in high amounts in a product. Further, such actives may be odorous and elevated levels of such ingredients may generate malodor on the treated surfaces and affect a freshness and sensory experience of users especially on surfaces of household items users come into contact frequently in an interior space but are difficult to clean, e.g., sofas, curtains, wall paper, or the like. Although perfume may be added to mask the inherent odor of such chemicals, the malodor may be detectable by the users.

Therefore, it is important to develop freshening compositions for malodor removal, freshening inanimate surfaces while providing second benefits of reducing bacteria and/or virus activity on inanimate surfaces or articles without a need of increasing levels of the antimicrobial actives while minimizing residue and/or stains on the treated surfaces.

### SUMMARY OF THE INVENTION

The present invention relates to a no-rinse freshening composition for treating an inanimate surface or article, the freshening composition comprising:
a) at least 85% by weight of the freshening composition of water;
b) a carboxylic acid;
c) a salt of citric acid;
d) a mixture of first and second antimicrobial agents, wherein each of the first and second antimicrobial agents is according to Formula (I);

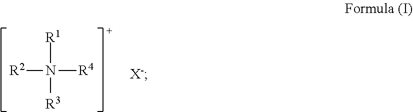

wherein
R¹ is a linear or branched C1 to C4 alkyl;
R² is a linear or branched C1 to C20 alkyl, benzyl or alkyl benzyl;
R³ is a linear or branched C6 to C20 alkyl, benzyl or alkyl benzyl;
R⁴ is a linear or branched C1 to C4 alkyl; and
X is an anion;
wherein the freshening composition comprises a neat pH of from 3 to 6 at room temperature; wherein a weight ratio of the total amount of the carboxylic acid and the salt of citric acid to the mixture of the first and second antimicrobial agents is from 1:1 to 10:1.

### DETAILED DESCRIPTION

The present invention is based on the surprising discovery that the freshening composition of the present invention comprising high levels of water, carboxylic acid, salt of citric acid and relatively low levels of a mixture of antimicrobial agents at a low pH can provide freshness benefits while improving antibacterial and antivirus efficacy on inanimate surfaces thereby providing an improved freshening composition for treating inanimate surfaces.

The freshening composition comprises a neat pH of from 3 to 6 at room temperature. The mixture of antimicrobial agents comprises first and second antimicrobial agents, wherein each of the first and second antimicrobial agents is according to Formula (I),

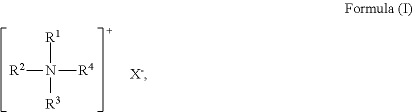

wherein

R¹ is a linear or branched C1 to C4 alkyl;

R² is a linear or branched C1 to C20 alkyl, benzyl or alkyl benzyl;

R³ is a linear or branched C6 to C20 alkyl, benzyl or alkyl benzyl;

R⁴ is a linear or branched C1 to C4 alkyl; and

X is an anion.

A weight ratio of the total amount of the carboxylic acid and the salt of citric acid to the mixture of the first and second antimicrobial agents is from 1:1 to 10:1. Room temperature is the range of air temperatures that people refer for indoor settings and may be from 20 to 25 degrees C. In particular, the freshening composition comprises a neat pH of from 3 to 6 at a temperature in the range from 20 to 25 degrees C., from 20 to 22 degrees C., or different combinations of the upper and lower temperatures described above or combinations of any number in the ranges listed above.

Without wishing to be bound by theory, a technical benefit of formulating a mixture of antimicrobial agents in a freshening composition comprising a low pH environment (i.e. composition comprising a neat pH of from 3 to 6 at room temperature) is that it enables a unscented or scented freshening product to deliver freshening and malodor removal benefits to a surface without characteristic odors of individual ingredients featuring prominently during use of the freshening product. In addition to providing the malodor removal benefits, the freshening product having the mixture can measurably reduce virus activity and bacteria activity on inanimate surfaces (e.g. by in vitro microbiology testing demonstrated in results as described hereinafter under Examples) thereby removing malodor caused by odor causing bacterium species. Without wishing to be bound by theory, providing a pH of from 3 to 6 at room temperature for a mixture of antimicrobial agents provides a low pH environment with higher concentration of protons to boost the performance of the mixture of antimicrobial agents to provide freshness and multiple secondary benefits of antivirus efficacy to reduce activity of specific enveloped and non-enveloped viruses and antibacterial efficacy to reduce activity of specific bacterium species. As a result, the levels of antimicrobial agents can be formulated at low levels to provide the antivirus and antibacterial efficacy without impacting a freshening product's scent profile.

The freshening composition is sprayable and is a phase-stable freshening composition that provides a consistent delivery of freshness in each spray.

In the following description, the composition described is a fabric freshening composition. However, it is contemplated that the composition may be configured for use in a variety of applications to provide freshness on inanimate surfaces or in the air.

Prior to describing the present invention in detail, the following terms are defined for clarity. Terms not defined should be given their ordinary meaning as understood by a skilled person in the relevant art.

The term “freshening” or “freshness” as used herein refers to providing a scent freshness benefit and/or reducing or eliminating malodors.

The term “freshening composition” as used herein refers to compositions for providing freshness on surfaces including inanimate surfaces.

The term “inanimate surface” as used herein refers to surfaces including but not limited to fabrics, carpets, household surfaces such as countertops, floors, garbage cans, ceilings, walls, carpet padding, air filters, and the like.

The term “permeable material” refers to any material that allows liquids or gases to pass through, and includes, but is not limited to, drywall, wall paper, wood, vinyl, plastic, plaster, wallboard, fabrics, upholstery, paper, wovens, natural polymers, synthetic polymers and inorganic materials and mixtures thereof. The permeable material may also include residue formed on any inanimate surface, and includes but is not limited to dust particles or grease on the inanimate surface.

The term “impermeable material” refers to any material that does not allow liquids or gases to pass through, and includes, but is not limited to metal, glass, ceramic, porcelain tile or the like.

The term “Clog P” as used herein refers to a calculated log P (“Clog P”) value of a perfume raw material (hereinafter “PRM”). An octanol/water partition coefficient of a PRM is the ratio between its equilibrium concentrations in octanol and in water. The partition coefficients of the PRM used in a freshening composition may more conveniently be given in the form of its logarithm to the base 10, LogP. The Clog P is determined by a model that computes the octanol-water partition coefficient (log P or logKow) for general organic molecules based directly on molecular structure. LogP is a measure of the distribution of a solute between two immiscible liquid phases, octanol and water, and is generally used as a relative measure of the hydrophobicity of a solute. One way of computing LogP of a PRM is using the ACD/Labs LogP software module from Advanced Chemistry Development, Inc. Details of the calculation of log P can be found on the ACD/Labs website (https://www.acdlabs.com/products/percepta/predictors/logp/). LogP values of PRMs calculating using the ACD/Labs LogP software module and the LogP values of PRMs are used in the selection of PRMs which are useful in the present invention as described hereafter in the Examples. However, it will be appreciated that another suitable way of measuring LogP is using the “Clog P” program from BioByte Corp (e.g., Clog P Version 4.0 and Manual 1999). CLOG P USER GUIDE, Version 4.0, BioByte Corp (1999) (http://www.bio-byte.com/bb/prod/clogp40.html). A further suitable way of measuring LogP is using CLOGP program from Daylight Chemical Information Systems, Inc. of Alison Viejo, Calif. The CLOGP Reference manual, Daylight Version 4.9, Release Date Feb. 1, 2008.

All percentages, parts and ratios are based upon the total weight of the compositions of the present invention, unless otherwise specified. All such weights as they pertain to listed ingredients are based on the active level and, therefore do not include solvents or by-products that may be included in commercially available materials, unless otherwise specified. The term “weight percent” may be denoted as “wt %” herein. All molecular weights as used herein are weight average molecular weights expressed as grams/mole, unless otherwise specified.

### Freshening Composition

A freshening composition according to the present invention comprises water in a level of at least 85% by weight of the composition, a carboxylic acid, a salt of citric acid, a mixture of first and second antimicrobial agents wherein the freshening composition comprises a pH of from 3 to 6 at room temperature, around 20 to 25 degrees C. The freshening composition may comprise a pH from 3 to 5 or from 4 to 5 or different combinations of the upper and lower pH values described above or combinations of any numerical values in the ranges listed above. A technical benefit of a pH in a range from 3 to 6 is that the antivirus and antibacterial efficacies are increased without increasing a concentration of the antimicrobial agents as shown in the Examples.

The freshening composition may comprise a weight ratio of the total amount of the carboxylic acid and the salt of citric acid to the mixture of the first and second antimicrobial agents of from 1:1 to 10:1.

The freshening composition may comprise at least 85%, by weight of the composition of water. The water may be in an amount from 85% to 99.5%, from 90% to 99.5%, from 95% to 99.5%, 95%, or different combinations of the upper and lower percentages described above or combinations of any integer in the ranges listed above, by weight of the composition. The water may be distilled, deionized or tap water. Having high levels of water enable a sprayable freshening composition while minimizing any visible residues and/or stains on fabric articles.

The freshening composition may comprise a carboxylic acid selected from the group consisting of: dicarboxylic acid, polycarboxylic acid, tricarboxylic acid and combinations thereof. The carboxylic acid may be used in the composition for maintaining the desired pH described hereinbefore. The dicarboxylic acid may include but is not limited to maleic acid. The polycarboxylic acid may include but is not limited to polyacrylic acid. It has been found that freshening compositions including one of: maleic acid, polyacrylic acid, and combinations thereof provide stable freshening compositions with prolonged shelf life.

As shown in the Examples, the carboxylic acid is tricarboxylic acid. The tricarboxylic acid may be selected from the group consisting of: citric acid, isocitric acid, aconitric acid and combinations thereof, preferably citric acid.

The carboxylic acid may be in an amount from 0.1% to 2.3%, from 0.15% to 2% or different combinations of the upper and lower percentages described above or combinations of any integer in the ranges listed above by weight of the freshening composition

The freshening composition may comprise a salt of citric acid selected from the group consisting of: sodium citrate, potassium citrate, aluminum citrate, diammonium citrate, ferric citrate, magnesium citrate, monosodium citrate, zinc citrate and mixtures thereof, preferably the salt of citric acid is sodium citrate.

The salt of citric acid may be in an amount of from 0.25% to 5%, from 0.25% to 1% or different combinations of the upper and lower percentages described above or combinations of any integer in the ranges listed above by weight of the freshening composition.

It has been found that a freshening composition comprising citric acid and sodium citrate provide stable freshening compositions with a prolonged shelf life.

A freshening composition of the present invention may comprise a mixture of first and second antimicrobial agents in an amount of from 0.05% to 0.7%, from 0.1% to 0.5%, from 0.2% to 0.4%, or different combinations of the upper and lower percentages described above or combinations of integers in the ranges listed above, by weight of the freshening composition.

Specifically, the mixture comprises a first antimicrobial agent and a second antimicrobial agent. Each of the first and second antimicrobial agents may comprise a structure according to Formula (I):

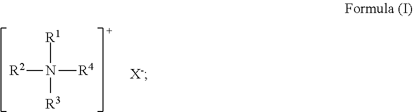

wherein

R¹ is a linear or branched C1 to C4 alkyl;

R² is a linear or branched C1 to C20 alkyl, benzyl or alkyl benzyl;

R³ is a linear or branched C6 to C20 alkyl, benzyl or alkyl benzyl;

R⁴ is a linear or branched C1 to C4 alkyl; and

X is an anion.

The first antimicrobial agent or the second antimicrobial agent may be selected from the group consisting of: alkyldimethylbenzyl ammonium chloride, dialkylmethylbenzyl ammonium chloride, dialkyldimethyl ammonium chloride, alkyldimethylethylbenzyl ammonium chloride, diisobutyl phenoxyethoxyethyl chloride, and blends thereof.

The dialkyldimethyl ammonium chloride may be selected from the group consisting of dioctyldimethyl ammonium chloride, octyldecyldimethyl ammonium chloride, didecyldimethyl ammonium chloride, decylisononyldimethyl ammonium chloride, diisodecyldimethyl ammonium chloride, and blends thereof.

The first and second antimicrobial agents may comprise different quaternary ammonium compounds.

One of the first and second antimicrobial agents may be a blend of C8 to C12 dialkyl-quaternary ammonium compounds, preferably the blend is in an amount of less than 0.5%, from 0.1% to 0.3%, from 0.1% to 0.2%, or different combinations of the upper and lower percentages described above or combinations of integers in the ranges listed above by weight of the freshening composition. A technical effect of using the blend in the above lower levels is to minimize odors which are characteristic of the blend from featuring prominently in the composition which can cause consumer to experience a less desirable scent experience.

The freshening composition may comprise a solvent for solubilizing the perfume. Specifically, the composition may comprise less than 10%, from 0.01% to 5%, from 0.01% to 3%, from 0.01% to 1%, from 0.01% to 0.05%, or different combinations of the upper and lower percentages described above or combinations of any integer in the ranges listed above of a solvent by weight of the freshening composition. The solvent may be selected from a group consisting of: an alcohol, a polyol and mixtures thereof. The solvent may comprise low molecular weight monohydric alcohols (e.g., ethanol, methanol, and isopropanol, or polyols, such as ethylene glycol and propylene glycol).

The freshening composition may be substantially free of a solvent, e.g. free of alcohol, free of ethanol, free of a polyol selected from the group consisting of: dipropylene glycol methyl ether, diethylene glycol, 3-methoxy-3-methyl-1-butanol, and mixtures thereof, and/or free of diethylene glycol.

The freshening composition may contain a surfactant to solubilize any excess hydrophobic organic materials, particularly any PRMs, and also optional ingredients (e.g., insect repelling agent, antioxidant, etc.) which can be added to the composition, that are not readily soluble in the composition, to form a clear solution. The freshening composition may comprise less than 3.5%, from 0.01% to 3%, from 0.01% to 1%, from 0.01% to 0.05% or different combinations of the upper and lower percentages described above or combinations of any integer in the ranges listed above of a surfactant by weight of the freshening composition. A suitable surfactant is a no-foaming or low-foaming surfactant. The surfactant may be selected from the group consisting of: nonionic surfactants, cationic surfactants, amphoteric surfactants, zwitterionic surfactants and mixtures thereof. Non-ionic surfactants may further include polyoxy-ethylene castor oil ethers or polyoxyethylene hardened castor oil ethers or mixtures thereof, which are either partially or fully hydrogenated. These ethoxylates have the following formula:

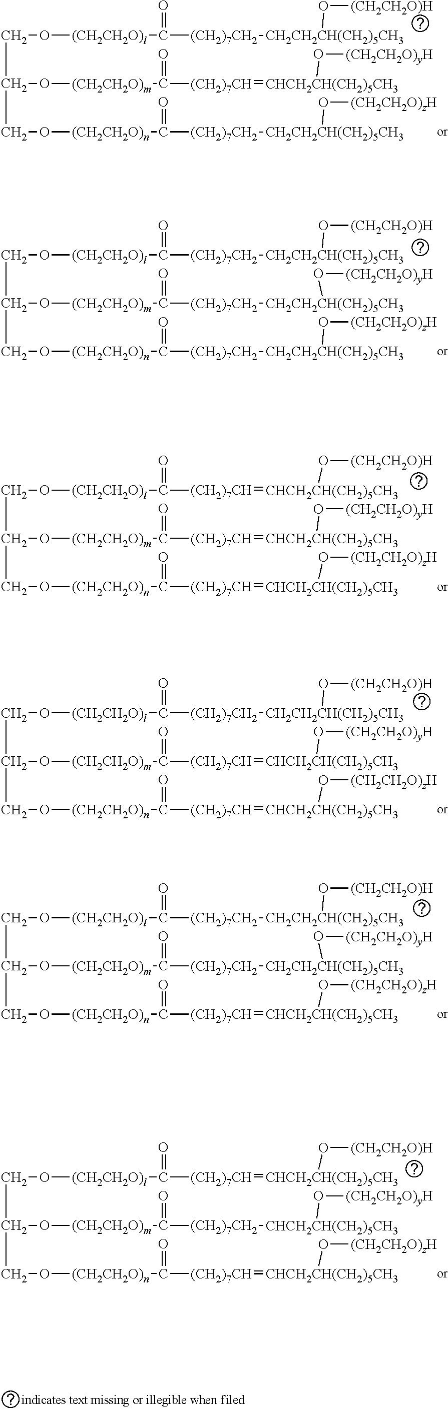

These ethoxylates can be used alone or in any mixture thereof. The average ethylene oxide addition mole number (i.e., 1+m+n+x+y+z in the above formula) of these ethoxylates is generally from about 7 to about 100, from about 20 to about 80, or different combinations of the upper and lower integers described above or combination of any integer n the ranges listed above. Exemplary nonionic surfactants may include castor oil surfactants commercially available from Nikko under tradenames HCO 40 and HCO60, from BASF under the tradenames Cremophor RH40, RH60 and C060, Basophor ELH60, from The Dow Chemical Company under the tradenames Tergitol™ ECO-20, Tergitol™ ECO-36 and Tergitol™ ECO-40.

Further examples of nonionic surfactants may include condensates of from 3 to 30 moles of ethylene oxide with an aliphatic alcohol of 8 to 22 carbon atoms, condensates of 5 to 30 moles of ethylene oxide with an alkyl phenol wherein the alkyl contains 9 to 15 carbon atoms and C8 to C22 alkyl dimethyl amine oxides. An exemplary nonionic surfactant may be a secondary alcohol ethoxylate known as Tergitol™ 15-S, available from The Dow Chemical Company.

Examples of ampholytic and zwitterionic surfactants are found in U.S. Pat. No. 3,929,678, Laughlin et al., issued Dec. 30, 1975 at Col, 19, line 38 through Col. 22 line 48. Examples of cationic surfactants are tetraalkyl quaternary ammonium salts having at least one alkyl chain of 8 to 22 carbon atoms, wherein the other alkyl groups can contain from 1 to 22 carbon atoms and wherein the anionic counterion is halogen ethylsulfate or methylsulfate.

The freshening composition of the present invention may comprise a malodor binding polymer. A malodor binding polymer is polymer having an available functional group (e g amine) that has the affinity to neutralize malodor components. Monomers having an available function group with an affinity to neutralize malodor components are also contemplated. In the case of amine based compounds, the amine will have an affinity for aldehyde malodors. The amine may react with aldehyde malodors and form a new compound, such as an aminol, imine, or enamine which is not odorous.

A malodor binding polymer may include amine based compounds, such as monoamines, amino acids, polyethyleneimine polymers (PEIs), modified PEIs, substituted PEIs; acrylic acid polymers, such as polyacrylate co-polymer (e.g. Acumer™ 9000 from Rohm & Haas), polyacrylic acid polymers (e.g. Acusol™ from Rohm & Haas), and modified acrylate copolymers (e.g. Aculyn™ from Rohm & Haas); and modified methacrylate copolymers (e.g. HydroSal™ from Salvona Technologies); or mixtures thereof.

### 1. Amine Based Compounds

The malodor binding polymer may be an amine based compound with a molecular weight greater than 100 Daltons and at least 10% of its amine groups are primary amines. The amine-based compound may be a polyamine with a molecular weight greater than 150 Daltons and 15% to 80% of its amine groups are primary amines. The malodor binding polymer may be an amine-based compound with a molecular weight greater than 1000 Daltons and from 0% to about 10% or less than 10% of its amine groups are primary amines.

A general structure for a primary amine compound useful in this invention is as follows:

B—(NH₂)ₙ;

wherein B is a carrier material, and n is an index of value of at least 1. Suitable B carriers include both inorganic and organic carrier moieties. By “inorganic carrier”, it is meant a carrier which is comprised of non- or substantially non-carbon based backbones.

Compounds containing a secondary amine group have a structure similar to the above with the exception that the compound comprises one or more —NH— groups as well as —NH2 groups. The amine compounds of this general type may be relatively viscous materials.

Exemplary amine based compounds are those selected from monoamines, aminoaryl derivatives, polyamines and derivatives thereof, polyamino acids and copolymers thereof, glucamines, dendrimers, PEIs, substituted amines and amides monoamines, or mixtures thereof.

a. Monoamines

Monoamines may be utilized in the present invention. Nonlimiting examples of suitable monoamines for use in the present invention include, but are not limited to, primary amines that also contain hydroxy and/or alkoxy functional groups, such as the 2-hydroxyamines and/or 3-hydroxyamines; primary or secondary amines that also contain a functional group that enhances deposition of the monoamine compared to monoamines that lack that functional group, especially when the monoamine is interacting with the benefit agent. Primary monoamines may also be used herein in combination with secondary monoamines. However, sufficient levels of the primary monoamine must be used to provide at least 10% of the total amine groups within such combinations as primary amine groups.

b. Aminoaryl Derivatives

Exemplary aminoaryl derivatives are the amino-benzene derivatives including the alkyl esters of 4-amino benzoate compounds, ethyl-4-amino benzoate, phenylethyl-4-aminobenzoate, phenyl-4-aminobenzoate, 4-amino-N′-(3-aminopropyl)-benzamide, or mixtures thereof.

c. Polyamines

Examples of suitable amino functional polymers containing at least one primary amine group for the purposes of the present invention are: Polyvinylamine with a MW of 300-2.10E6 Daltons (e.g Lupamine series 1500, 4500, 5000, 9000 available from BASF); Polyvinylamine alkoxylated with a MW of ≥600 Daltons and a degree of ethoxylation of at least 0.5; Polyvinylamine vinylalcohol-molar ratio 2:1, polyvinylaminevinylformamide-molar ratio 1:2 and polyvinylamine vinylformamide-molar ratio 2:1; Triethylenetetramine, diethylenetriamine, tetraethylenepentamine; Bis-aminopropylpiperazine; amino substituted polyvinylalcohol with a MW ranging from 400-300,000 Daltons; polyoxyethylene bis[amine] available from e.g. Sigma; polyoxyethylene bis[6-aminohexyl] available from e.g. Sigma; N,N′-bis-(3-aminopropyl)-1,3-propanediamine linear or branched (TPTA); N,N′-bis-(3-aminopropyl)ethylenediamine; bis(amino alkyl)alkyl diamine, linear or branched; and 1,4-bis-(3-aminopropyl)piperazine (BNPP).

d. Polyamino Acids

Suitable amine based compounds include polyamino acids. Polyamino acids are made up of amino acids or chemically modified amino acids. The amino acids may be selected from cysteine, histidine, isoleucine, tyrosine, tryptophane, leucine, lysine, glutamic acid, glutamine, glycine, alanine, aspartic acid, arginine, asparagine, phenylalanine, proline, serine, histidine, threonine, methionine, valine, and mixtures thereof. Amino acid derivatives may be tyrosine ethylate, glycine methylate, tryptophane ethylate, or mixtures thereof; homopolymers of amino acids; hydroxyamines; poly amino acids; or mixtures thereof.

In chemically modified amino acids, the amine or acidic function of the amino acid has reacted with a chemical reagent. This is often done to protect these chemical amine and acid functions of the amino acid in a subsequent reaction or to give special properties to the amino acids, like improved solubility. Examples of such chemical modifications are benzyloxycarbonyl, aminobutyric acid, butyl ester, and pyroglutamic acid. More examples of common modifications of amino acids and small amino acid fragments can be found in the Bachem, 1996, Peptides and Biochemicals Catalog.

One polyamino acid is polylysine, alternatively polylysines or polyamino acids where more than 50% of the amino acids are lysine, since the primary amine function in the side chain of the lysine is the most reactive amine of all amino acids. One polyamino acid has a molecular weight of 500 to 10,000,000, alternatively between 2000 and 25,000.

The polyamino acid can be cross linked. The cross linking can be obtained for example by condensation of the amine group in the side chain of the amino acid like lysine with the carboxyl function on the amino acid or with protein cross linkers like PEG derivatives. The cross linked polyamino acids still need to have free primary and/or secondary amino groups left for neutralization. Cross linked polyamino acid has a molecular weight of 20,000 to 10,000,000; alternatively between 200,000 and 2,000,000.

The polyamino acid or the amino acid can be co-polymerized with other reagents like for instance with acids, amides, acyl chlorides, aminocaproic acid, adipic acid, ethylhexanoic acid, caprolactam, or mixtures thereof. The molar ratio used in these copolymers ranges from 1:1 (reagent/amino acid (lysine)) to 1:20, alternatively from 1:1 to 1:10. The polyamino acid like polylysine can be unethoxylated or partially ethoxylated so long as the requisite amount of primary amine remains in the polymer.

e. Dendrimers

Also useful amine based compounds are polypropylenimine dendrimers and the commercially available Starburst® polyamidoamines (PAMAM) dendrimers, generation G0-G10 from Dendritech and the dendrimers Astromols®, generation 1-5 from DSM being DiAminoButane PolyAmine DAB (PA)x dendrimers with x=2<n>x4 and n being generally comprised between 0 and 4.

f. PEIs

In one embodiment, the malodor binding polymer is a PEI. It has been surprisingly discovered that amine based polymers at a pH of about 4 to about 8, alternatively above 5 to about 8, alternatively 7 can neutralize amine based odors. PEIs have the following general formula:

—(CH2-CH2-NH)ₙ—; n=10-10₅

Homopolymeric PEIs are branched, spherical polyamines with a well defined ratio of primary, secondary and tertiary amine functions. They are best described in the following partial structural formula:

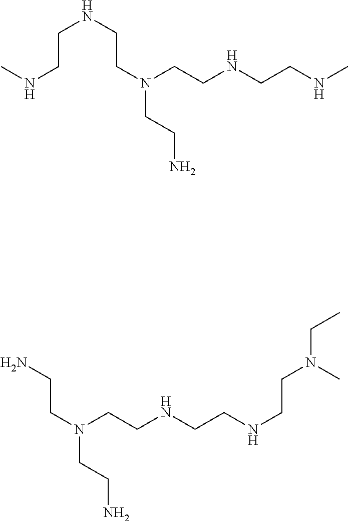

The chemical structure of homopolymeric PEIs follows a simple principle: one amine function—two carbons.

The freshening composition may comprise a homopolymeric polyethylenimine having a molecular weight of about 800 to about 2,000,000, alternatively about 1,000 to about 2,000,000, alternatively about 1,200 to about 25,000, alternatively about 1,300 to about 25,000, alternatively about 2,000 to about 25,000, alternatively about 10,000 to about 2,000,000, alternatively about 25,000 to about 2,000,000, alternatively about 25,000. Exemplary homopolymeric PEIs include those that are commercially available under the tradename Lupasol® from BASF. Lupasol products are usually obtained through polymerization of the ethylenimine monomer. The ethylenimine monomer has totally reacted in the polymer matrix. Suitable Lupasol products include Lupasol FG (MW 800), G20wfv (MW 1300), PR8515 (MW 2000), WF (MW 25,000), FC (MW 800), G20 (MW 1300), G35 (MW 1200), G100 (MW 2000), HF (MW 25,000), P (MW 750,000), PS (MW 750,000), SK (MW 2,000,000), SNA (MW 1,000,000).

The freshening composition may comprise Lupasol HF or WF (MW 25,000), P (MW 750,000), PS (MW 750,000), SK (MW 2,000,000), G20wfv (MW 1300) or PR 1815 (MW 2000), or Epomin SP-103, Epomin SP-110, Epomin SP-003, Epomin SP-006, Epomin SP-012, Epomin SP-018, Epomin SP-200, or partially alkoxylated polyethyleneimine, like polyethyleneimine 80% ethoxylated from Aldrich. The freshening composition may comprise Lupasol WF (MW 25,000).

Also suitable amine based compounds for use in the freshening composition are modified PEIs, partially alkylated polyethylene polymers, PEIs with hydroxyl groups, 1,5-pentanediamine, 1,6-hexanediamine, 1,3 pentanediamine, 3-dimethylpropanediamine, 1,2-cyclohexanediamine, 1,3-bis(aminomethyl)cyclohexane, tripropylenetetraamine, bis(3-aminopropyl)piperazine, dipropylenetriamine, tris (2-aminoethylamine), tetraethylenepentamine, bishexamethylenetriamine, bis(3-aminopropyl) 1,6-hexamethylenediamine, 3,3′-diamino-N-methyldipropylamine, 2-methyl-1,5-pentanediamine, N,N,N′,N′-tetra(2-aminoethyl)ethylenediamine, N,N,N′,N′-tetra(3-aminopropyl)-1,4-butanediamine, pentaethylhexamine, 1,3-diamino-2-propyl-tert-butylether, isophorondiamine, 4,4′,-diaminodicyclohylmethane, N-methyl-N-(3-aminopropyl)ethanolamine, spermine, spermidine, 1-piperazineethaneamine, 2-(bis(2-aminoethyl)amino)ethanol, ethoxylated N-(tallowalkyl)trimethylene diamines,polyloxy (methyl-1,2-ethanediyl)], α-(2-aminomethyl-ethoxy)-(=C.A.S No. 9046-10-0); polyloxy (methyl-1,2-ethanediyl)], α-hydro-)-ω-(2-aminomethylethoxy)-, ether with 2-ethyl-2-(hydroxymethyl)-1,3-propanediol (=C.A.S, No. 39423-51-3); commercially available under the tradename Jeffamines T-403, D-230, D-400, D-2000; 2,2′,2″-triaminotriethylamine; 2,2′-diamino-diethylamine; 3,3′-diamino-dipropylamine, 1,3 bis aminoethyl-cyclohexane commercially available from Mitsubishi, and the C12 Sternamines commercially available from Clariant like the C12 Sternamin(propylenamine)n with n=¾.

Suitable levels of malodor binding polymer are from about 0.01% to about 2%, alternatively from about 0.01% to about 1%, alternatively about 0.01% to about 0.8%, alternatively about 0.01% to about 0.6%, alternatively about 0.01% to about 0.1%, alternatively about 0.01% to about 0.07%, alternatively about 0.07%, by weight of the freshening composition. Compositions with higher amount of malodor binding polymer may make fabrics susceptible to soiling and/or leave unacceptable visible stains on fabrics as the solution evaporates off of the fabric.

The freshening composition may utilize one or more malodor counteractants. Malodor counteractants may include components which lower the vapor pressure of odorous compounds, solubilize malodor compounds, physically entrap odors (e.g. flocculate or encapsulate), physically bind odors, or physically repel odors from binding to inanimate surfaces. For example, aliphatic aldehydes react with amine odors, such as fish and cigarette odors. When used in combination with the malodor binding polymer, the freshening composition may neutralize a broader range of malodor causing materials which, in turn, further reduces malodors in the air or on inanimate surfaces.

Specifically, the freshening composition may include a malodor counteractant, wherein the malodor counteractant is selected from the group consisting of: polyols, cyclodextrin and derivatives thereof, amine functional polymers, aldehydes, and combinations thereof. The malodor counteract may be cyclodextrin. As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof.

The freshening composition may further include a buffering agent to maintain the desired pH. The buffering agent may be an acidic buffering agent. Other suitable buffering agents for the freshening compositions include biological buffering agents. Some examples are nitrogen-containing materials, sulfonic acid buffers like 3-(N15489 morpholino)propanesulfonic acid (MOPS) or N-(2-Acetamido)-2-aminoethanesulfonic acid (ACES), which have a near neutral 6.2 to 7.5 pKa and provide adequate buffering capacity at a neutral pH. Other examples are amino acids such as lysine or lower alcohol amines like mono-, di-, and tri-ethanolamine or methyldiethanolamine or derivatives thereof. Other nitrogen containing buffering agents are tri(hydroxymethyl)amino methane (HOCH2)5 3CNH3 (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis (2-hydroxyethyl)glycine (bicine) and N-tris (hydroxymethyl)methyl glycine (tricine). Mixtures of any of the above are also acceptable.

The freshening compositions may include a secondary or tertiary amine. The freshening compositions may contain at least about 0%, alternatively at least about 0.001%, alternatively at least about 0.01%, by weight of the composition, of a buffering agent. The composition may also contain no more than about 2%, alternatively no more than about 0.75%, alternatively no more than about 0.5%, by weight of the composition, of a buffering agent.

The freshening composition may, optionally, include a wetting agent that provides a low surface tension that permits the composition to spread readily and more uniformly on hydrophobic surfaces like polyester and nylon. It has been found that the freshening composition, without such a wetting agent will not spread satisfactorily. The spreading of the composition also allows it to dry faster, so that the treated material is ready to use sooner. Furthermore, a composition containing a wetting agent may penetrate hydrophobic, oily soil better for improved malodor neutralization. A composition containing a wetting agent may also provide improved “in-wear” electrostatic control. For concentrated compositions, the wetting agent facilitates the dispersion of many actives such as antimicrobial actives and perfumes in the concentrated freshening compositions. Non-limiting examples of wetting agents include block copolymers of ethylene oxide and propylene oxide. Suitable block polyoxyethylene-polyoxypropylene polymeric surfactants include those based on ethylene glycol, propylene glycol, glycerol, trimethylolpropane and ethylenediamine as the initial reactive hydrogen compound. Polymeric compounds made from a sequential ethoxylation and propoxylation of initial compounds with a single reactive hydrogen atom, such as C12-18 aliphatic alcohols, are not generally compatible with the cyclodextrin. Certain of the block polymer surfactant compounds designated Pluronic™ and Tetronic™ by the BASF-Wyandotte Corp., Wyandotte, Mich., are readily available.

Non-limiting examples of cyclodextrin-compatible wetting agents of this type are described in U.S. Pat. No. 5,714,137 and include the SILWET™ surfactants available from Momentive Performance Chemical, Albany, N.Y. Exemplary SILWET™ surfactants are as follows in Table 1 below. However, it will be appreciated that mixtures of the following surfactants may also be used in the present invention.

TABLE 1

| SIL WET ™ Surfactants | Average MW |
|---|---|
| L-7608 | 600 |
| L-7607 | 1,000 |
| L-77 | 600 |
| L-7605 | 6,000 |
| L-7604 | 4,000 |
| L-7600 | 4,000 |
| L-7657 | 5,000 |

The total amount of surfactants (e.g. solubilizer, wetting agent) in the freshening composition is from 0 wt. % to about 3 wt. % or no more than 3 wt. %, alternatively from 0 wt. 5% to about 1 wt. % or no more than 1 wt. %, alternatively from 0 wt. % to about 0.9 wt. % or no more than 0.9 wt. %, alternatively from 0 wt. % to about 0.7 wt. % or no more than 0.7 wt. %, alternatively from 0 wt. % to about 0.5 wt. % or no more than 0.5 wt. %, alternatively from 0 wt. % to 0.3 wt. % or no more than about 0.3 wt. %, by weight of the composition. Compositions with higher concentrations can make fabrics susceptible to soiling and/or leave unacceptable visible stains on fabrics as the solution evaporates. The weight ratio of sulfur containing pro-perfume to total surfactant may be from about 1:1 to 1:250, or from about 1:1 to about 1:60, or from about 1:1 to about 1:30.

### Method of Manufacture

The freshening composition can be made in any suitable manner known in the art. All of the ingredients can simply be mixed together. In certain embodiments, it may be desirable to make a concentrated mixture of ingredients such as a pre-mix and dilute by adding the same to an aqueous carrier before dispersing the composition into the air or on an inanimate surface.

All materials are added until fully dispersed and visually dissolved. In a separate vessel, the solubilizing materials (surfactants and solvents) and perfume are mixed until homogenous. The solution of solubilizing materials and perfume are then added to the first mixing vessel, and mixed until homogenous.

### Method of Use

The freshening composition can be used by dispersing, e.g., by placing the freshening composition into a dispenser, such as a spray dispenser and spraying an effective amount into the air or onto the desired inanimate surface or article. “Effective amount”, when used in connection with the amount of the freshening composition, means an amount sufficient to provide at least about 4 hours, or at least about 6 hours, or at least about 8 hours, or at least about 24 hours of freshness or scent to the treated air, surface, or article, yet not so much as to saturate or create a pool of liquid on an article or surface and so that, when dry, there is no visual deposit readily discernible. Where malodor reducing ingredients are included, “effective amount”, when used in connection with the amount of the freshening composition, means an amount that provides the foregoing and also provides neutralization of a malodor to the point that it is not discernible by the human sense of smell, yet not so much as to saturate or create a pool of liquid on an article or surface and so that, when dry, there is no visual deposit readily discernible. Dispersing can be achieved by using a spray device, a roller, a pad, or other product forms described hereinafter.

The present invention also relates to a method of demonstrating efficacy of a no-rinse antimicrobial freshening composition for reducing virus activity and bacteria activity on an inanimate surface, the method comprising:
a) providing a freshening composition;
b) treating at least a portion of an inanimate surface having at least one virus and at least one bacterium disposed on the inanimate surface with the freshening composition for at least 20 minutes

The composition may comprise an antivirus activity value of at least 1, at least 2, or at least 3, on at least one enveloped virus and at least one non-enveloped virus disposed on the inanimate surface at the end of a time period of at least 20 minutes. The enveloped virus may be selected from the group consisting of: Influenza type A virus (H3N2) ATCC VR-1679, and the non-enveloped virus may be selected from the group consisting of: Feline calicivirus (FCV), Rotavirus.

The composition may comprise an antibacterial activity value of at least 1, at least 2, or at least 3, on at least one bacterium disposed on the inanimate surface at the end of a time period of at least 20 minutes. The bacterium may be selected from the group consisting: S. aureus ATCC 6538, P. mirabilis ATCC 7002, E. coli NBRC 3972, K. pneumoniae NBRC 13277, E. hirae ATCC 10541, P. aeruginosa ATCC 15442, E. coli ATCC 10536, E. aerogenes ATCC 13048, S. enterica ATCC 10708, K. pneumoniae ATCC 4352.

The inanimate surface or article may be selected from the group consisting of: a permeable soft surface, a permeable hard surface, and mixtures thereof. The permeable soft surface may be selected from the group consisting of: fabrics, drywall, wovens, natural polymers, synthetic polymers, inorganic materials and mixtures thereof. The permeable hard surface may be selected from the group consisting of: finished laminate and wood, unfinished wood, painted wood, plastics and mixtures thereof.

### Product Forms

The freshening composition may be provided in a product form selected from the group consisting of: a refillable package, a spray package, a packaging container, and a wipe.

### Wipes

The freshening compositions of the present invention may be impregnated into a commercially available substrate such as the substrates discussed in U.S. RE38505, U.S. RE38105, and U.S. Pat. No. 6,936,330, all of which are incorporated herein by reference. In one embodiment, the substrate may be a non-woven, wet-wipe for deodorizing, disinfecting, or cleaning multiple surfaces including inanimate household surfaces.

### Packaging Container

The freshening compositions of the present invention can be contained in plastic containers constructed of hydrophilic perfume compatible materials. These materials avoid complexing, with hydroplilic perfume ingredients, such that absorption by and/or transmission through plastic containers is minimized. Suitable hydrophilic perfume compatible materials can be readily identified by determining the average hydrophilic perfume loss through gas chromatography analysis. Hydrophilic perfume compatible materials result in an average hydrophilic perfume ingredient loss of less than about 50% alternatively less than about 20%, alternatively less than about 15% and alternatively less than about 10% of the originally present individual hydrophilic perfume ingredients.

Freshening compositions containing a substantial amount of hydrophilic perfume ingredients can be stored in plastic container constructed of at least 80% hydrophilic perfume compatible materials for 8 weeks at ambient temperature. After storage, gas chromatography analysis is used to determine the amount of the various perfume ingredients remaining in the aqueous composition and approximate loss is calculated based on the amount of each ingredient originally present.

An effective amount of hydrophilic perfume compatible materials suitable for the present invention is at least about 80%, alternatively about 80% to about 100%, alternatively about 90% to about 100%, and alternatively 100%, by weight of the container. Non-limiting examples of hydrophilic perfume compatible materials are any resins of high density polyethylene (HDPE), low density polyethylene (LDPE), polyvinyl chloride (PVC), polypropylene (PP), polystyrene (PS), polyethylene-co-vinyl alcohol (EVOH), fluorinated polymer such as Aclar®, acrylonitrile-methyl acrylate copolymer such as Barex®, or mixtures thereof. Alternatively HDPE is utilized in the present invention.

In one embodiment, an HDPE bottle, from Plastipak Packaging Inc. Champaign, Ill., is used to contain the aqueous composition of the present invention. HDPE bottles can be made by any blow molding, injection molding, and thermoform process known in the art. For example, for blow molded bottles, heat softened HDPE is extruded as a hollow tube into a mold cavity and forced by pressurized air against the walls of the cold mold cavity to form the bottle. The bottle solidifies by cooling.

It has been found that the perfume compositions having a Clog P of less than about 3 are not fully absorbed into and/or transmitted through the hydrophilic perfume compatible materials such as PP and HDPE. Thus, this assists in preventing transmission of perfume ingredients through plastic containers; which in turn provides consumer noticeable longer lasting fragrance life.

Any of the hydrophilic perfume compatible materials can be used in conjunction with one or more barrier materials including amorphous carbon, silicone oxide or mixtures thereof and metallized coating.

### Freshening Product

The freshening composition can be packaged in any suitable package to form a freshening product. The package may be in the form of a spray dispenser and the freshening product may be a freshening sprayer product. The spray dispenser may be transparent or translucent such that the freshening composition is visible or at least partially visible from outside of the freshening product.

The spray dispenser may hold various amounts of freshening composition. The spray dispenser may be capable of withstanding internal pressure in the range of about 20 p.s.i.g. to about 140 psig, alternatively about 80 to about 130 p.s.i.g. The total composition output and the spray droplet/particle size distribution may be selected to support the particulate removal efficacy but avoid a surface wetness problem. Total output is determined by the flow rate of the composition as it is released from the spray dispenser. To achieve a spray profile that produces minimal surface wetness, it is desirable to have a low flow rate and small 5 spray droplets.

The flow rate of the composition being released from the spray dispenser may be from about 0.0001 grams/second (g/s) to about 2.5 grams/second. Alternatively, the flow rate may be from about 0.001 grams/second to about 2.5 grams/second, or about 0.01 grams/second to about 2.0 grams/second. For an aerosol sprayer, the flow rate is determined by measuring the rate of composition expelled by a spray dispenser for any 60 second period of use.

The Sauter Mean Diameter of the spray droplets may be in the range of from about 10 μm to about 100 μm, alternatively from about 20 μm to about 60 μm. At least some of the spray droplets are sufficiently small in size to be suspended in the air for at least about 10 minutes, and in some cases, for at least about 15 minutes, or at least about 30 minutes. Small particles can be efficiently created when the spray is dispensed in a wide cone angle. For a given nozzle component and delivery tube, cone angles can be modified by varying the insertion depth of the nozzle in the delivery tube. The cone angle may be greater than about 20 degrees, or greater than about 30 degrees, or greater than about 35 degrees, or greater than about 40 degrees, or greater than about 50 degrees.

The spray dispenser may be configured to spray the freshening composition at an angle that is between an angle that is parallel to the base of the container and an angle that is perpendicular thereto. The desired size of spray droplets can be delivered by other types of spray dispensers that are capable of being set to provide a narrow range of droplet size. Such other spray dispensers include, but are not limited to: foggers, ultrasonic nebulizers, electrostatic sprayers, and spinning disk sprayers. The spray dispenser may be comprised of various materials, including plastic, metal, glass, or combinations thereof. The spray dispenser may be pressurized, unpressurized or non-aerosol.

A non-aerosol spray dispenser may include a pre-compression trigger sprayer. One suitable non-aerosol spray dispenser is a plastic non-aerosol dispenser. The dispenser may be constructed of polyethylene such as a high-density polyethylene; polypropylene; polyethyleneterephthalate (“PET”); vinyl acetate, rubber elastomer, and combinations thereof. The spray dispenser may be made of clear PET. Another suitable spray dispenser includes a continuous action sprayer, such as FLAIROSOL™ dispenser from Afa Dispensing Group. The FLAIROSOL™ dispenser includes a bag-in-bag or bag-in-can container with a pre-compression spray engine, and aerosol-like pressurization of the freshening composition. An example of the FLAIROSOL™ dispenser is described in U.S. Pat. No. 8,905,271B2.

A pressurized spray dispenser may include a propellant. Various propellants may be used. The propellant may comprise hydrocarbon(s); compressed gas(es), such as nitrogen, carbon dioxide, air; liquefied gas(es) or hydrofluoro olefin (“HFO”); and mixtures thereof. The product may comprise a propellant selected from the group consisting of compressed gas such as compressed air, compressed nitrogen, and combinations thereof. Propellants listed in the U.S. Federal Register 30 49 C.F.R. § 1.73.115, Class 2, Division 2.2 are considered acceptable. The propellant may particularly comprise a trans-1,3,3,3-tetrafluoroprop-1-ene, and optionally a CAS number 1645-83-6 gas. Such propellants provide the benefit that they are not flammable, although the freshening compositions are not limited to inflammable propellants. One such propellant is commercially available from Honeywell International of Morristown, N.J. under the trade name HFO-5 1234ze or GWP-6. If desired, the propellant may be condensable. By “condensable”, it is meant that the propellant transforms from a gaseous state of matter to a liquid state of matter in the spray dispenser and under the pressures encountered in use. Generally, the highest pressure occurs after the spray dispenser is charged with a freshening composition but before that first dispensing of that freshening composition by the user. A condensable propellant provides the benefit of a flatter depressurization curve as the freshening composition is depleted during usage.

The pressurized spray dispenser may be free of a hydrocarbon propellant. The freshening composition may be delivered from the spray dispenser which includes delivery components including but not limited to a valve to control flow and to seal the freshening composition within the spray dispenser, a button actuator and a nozzle for dispensing the freshening composition to the environment. The freshening composition may be contained in a bag-in-can plastic spray dispenser.

The following examples are intended to more fully illustrate the present invention and are not to be construed as limitations of the present invention since many variations thereof are possible without departing from the scope of the present invention. All parts, percentages and ratios used herein are expressed as percent weight unless otherwise specified.

### EXAMPLES

Test equipment/materials and test freshening compositions are first described under Materials, then Test Methods are provided, and lastly results are discussed. Data is provided demonstrating the freshening compositions of the present invention having freshness benefits and secondary benefits of improved antivirus efficacy, improved antibacterial efficacy on an inanimate surface in an interior environment.

In the following Examples, the freshening composition evaluated is designed as a consumer product, such as a fabric freshening product for freshening soft surfaces in an interior space to deliver a variety of benefits such as bacteria activity reduction and virus activity reduction on inanimate surfaces, freshening, malodor removal. However, it is contemplated that the freshening composition may be configured for use in a variety of applications to provide a primary benefit of freshness and a secondary benefit of improved antivirus and antibacterial efficacy on inanimate surfaces.

### Materials

Table 2 describes Inventive and Comparative Compositions which are evaluated. Each of the Inventive and Comparative Compositions is prepared using conventional methods and equipment according to the following steps:
1) mixing of the above components using overhead mixing/magnetic stir bar equipment IKA/RW20VWR/58947-128 (A variety of stir bars are used dependent on the amount used for the samples—this is one example that can be used) to form a freshening composition;
2) determining a pH of the freshening composition using a pH meter (An example of a pH meter is Thermo Scientific/E08212).

Inventive Compositions #1, #2 and #3 have a quaternary ammonium compound, a blend of quaternary ammonium compounds, a tricarboxylic acid and a salt of citric acid, and pH in different levels. Comparative Compositions #4, #5, #6 do not have sodium citrate and has citric acid in an amount of 0.015% by weight of the composition.

TABLE 2

| | Inventive Composition(s) | | | Comparative Composition(s) | | |
|---|---|---|---|---|---|---|
| Example Identifier No | #1 | #2 | #3 | #4 | #5 | #6 |
| Ingredients by weight | | | | | | |
| of the composition, wt % | | | | | | |
| Water | 93.50 | 93.50 | 93.50 | 93.50 | 93.50 | 93.50 |
| Antimicrobial Active - | 0.12 | 0.12 | 0.12 | — | — | 0.12 |
| Dioctyldimethylammoniumchloride | | | | | | |
| (cationic surfactant) | | | | | | |
| Antimicrobial Active - | 0.12 | 0.12 | 0.12 | 0.139 | 0.18 | 0.12 |
| Didecyldimethylammoniumchloride | | | | | | |
| (cationic surfactant) | | | | | | |
| Citric Acid | 0.15 | 0.30 | 2.05 | 0.015 | 0.015 | 0.015 |
| Sodium Citrate | 0.30 | 0.30 | 0.30 | 0 | 0 | 0 |
| Other Ingredients* | 5.81 | 5.66 | 3.91 | 6.346 | 6.305 | 6.245 |
| Total Amount | 100 | 100 | 100 | 100 | 100 | 100 |
| pH | 5 | 4 | 3 | 6.75 | 6.75 | 6.75 |
| Weight Ratio of Citric Acid | 0.45:0.24 | 0.60:0.24 | 2.35:0.24 | 0.015:0.14 | 0.015:0.18 | 0.015:0.24 |
| and/or Sodium Citrate to | (2:1) | (2.5:1) | (9.8:1) | (0.1:1) | (0.08:1) | (0.06:1) |
| Antimicrobial Actives | | | | | | |
| Total level of Citric Acid | 0.69 | 0.84 | 2.59 | n/a | n/a | n/a |
| and Sodium Citrate and | | | | | | |
| Dioctyldimethylammoniumchloride | | | | | | |
| and Dioctyldimethylammoniumchloride | | | | | | |
| Weight Ratio of | 1:1 | 1:1 | 1:1 | — | — | 1:1 |
| Dioctyldimethylammoniumchloride | | | | | | |
| to Dioctyldimethylammoniumchloride | | | | | | |

*Other ingredients include Wetting Surfactant, Solvent and Malodor Counteractant.

### I. Test Method for Evaluating Antibacterial Efficacy of Freshening Composition

This test method is to evaluate an antibacterial efficacy of a freshening composition in reducing bacteria growth on a soft permeable surface in an interior environment such as for example, a living room having a fabric sofa.
1. Subculture the test bacteria below from glycerol stock onto a TSA plate (transfer #1) and incubate at 35±2° C. for 24±4 h.
2. Subculture the TSA plates from Day 1 onto another TSA plate (transfer #2) and incubate at 35±2° C. for 24±4 h.
3. Prepare the test inoculums by using a loop and remove colonies from the plates and make a bacterial suspension in saline.
4. Mix 9 parts of the above bacterial suspension and 1 part of sterile 0.3% BSA solution
5. Prepare 3 pieces of autoclaved and dried 35×35 mm fabric carrier for each sample and control, and place each of them in a sterile Petri dish.
6. Inoculate 50 μL of respective inoculum onto each fabric carrier, including the controls. Use a forceps to hold one end of the fabric carrier while the inoculum is inoculated. Allow the inoculum to cover the whole fabric carrier before putting it back onto the Petri dish.
7. Dry the inoculated fabric at 35±2° C. for 30 min.
8. For test, pipette 2.0 ml product onto the inoculated fabric. For control, inoculate 2.0 mL of 0.05% (v/v) Tween 80 in 0.85% (w/v) saline per fabric carrier.
9. Dry the treated fabric carrier at ambient condition for 20 min. Do not cover the Petri dish.
10. After incubation, aseptically transfer each fabric carrier to a 50 mL tube containing 20 mL MLBT and vortex for 30 s. Allow the fabric carrier to be neutralized for at least 5 min before performing serial dilution for plating.
11. Perform 10× serial dilutions up to 10⁻⁸ for inoculum, up to 10⁻⁵ for controls and up to 10⁻⁴ for samples. Perform pour plating using molten TSA (˜48° C.) for 10⁻⁶, 10⁻⁷ and 10⁻⁸ of inoculum, 10⁻³, 10⁻⁴ and 10⁻⁵ of controls, and neat to 10⁻⁴ for samples using 1 mL in duplicate.
12. Incubate the plates at 35±2° C. for 48±2 h.
13. The target dilution will have plates containing 30-300 CFU.

### II. Virucidal Test Method for Evaluating Antivirus Efficacy of Freshening Composition

This test method is to evaluate an antivirus efficacy of a freshening composition in reducing bacteria growth on a soft permeable surface in an interior environment such as for example, a living room having a fabric sofa. The test method is performed according to the following sub-methods A, B, C, D and E described hereinafter.

### A. Subculture of Host Cell

1. Drain an extra growth medium of the flask after confirmation of a confluent growth of cells under a microscope
2. Add 5 ml of 0.01 mol/L phosphate buffered saline (PBS), wash the surface of the grown cells on the bottom of flask by the solution and drain the added PBS. Repeat this washing procedure 3 times.
3. Add 1 ml of Trypsin EDTA solution in the flask, spread the solution over whole surface and drain extra Trypsin EDTA solution.
4. Put the flask in CO2 incubator at 37 C for 10 min±1 min to keep warm.
5. Observe visually the flask if the grown cells are starting to come off, if confirmed, tap the side of the flask and disperse the cells.
6. Add 5 ml of the growth medium in the flask and pipetting the medium to make mild mix well to avoid damage to the cells.
7. Prepare a new flask and add 20 ml of growth medium
8. Add 1 ml of the cell suspension by a pipette.
9. Close the cap of the flask and put the flask in CO2 incubator at 37 C for 5 days to culture.

### B. Inoculum:

1. Drain the growth medium from the flask with the cultured MDCK cells for influenza virus, CRFK cells for Feline calicivirus, and Rhesus Monkey Kidney Epithelial Cells for Rotavirus in the monolayer.
2. Wash the surface of the cultured cells with EMEM and drain the medium. Repeat the washing procedure 2 times.
3. Inoculate the influenza virus, Feline calicivirus, or Rotavirus suspension prepared to be a concentration of 10³ to 10⁴ PFU/ml on the surface of cell in the flask and spread to the whole surface.
4. Put the flask in CO2 incubator at 34 C and keep it for 1 h to absorb the virus to the cells.
5. Put EMEM containing 1.5 ppm Trypsin derived from beef pancreas in the flask.
6. Put the flask in the CO2 incubator at 34 C for 1 top 3 days to multiply the virus.
7. Observe the cytopathic effect under an inverted microscope and judge the multiplication of the virus. If the multiplication of the virus is confirmed, centrifuge the multiplied virus suspension by using the centrifuge at 4 C and 1,000 g for 15 min.
8. Take the supernatant suspension from the centrifugal tube after the centrifugation. Add to the virus suspension FBS at the final concentration of 5% and this is the final viral inoculum.

### C. Test Procedure

1. Place a fabric carrier (60 mm×60 mm) in a sterile petri dish. Pipette 0.05 ml of the viral inoculum onto the fabric carrier. Treat the carrier with 2.0 ml of test sample or PBS (negative control).
2. Keep the petri dish with the lid open for 20 min in a safety cabinet.
3. Upon completion of contact time, immediately transfer the carrier to a test tube contains 20 ml of neutralizer and agitate them by vortex mixer for 5 s and 5 times.
4. Prepare a series of 10-fold dilutions of the mixture by using EMEM. Measure the infectivity titer per 0.1 ml of the mixture by plaque assay and calculate the viral infectivity titer per fabric carrier.

### D. Plaque Assay

1. Pick up a 6 well plate with monolayer grown cells in the each well and observe under microscope of a confluent state of grown cells. After the confirmation of confluent state, drain extra cell growth medium from the plate.
2. Add 3 ml of maintenance medium, wash the surface by the medium and drain the extra maintenance medium. Repeat this 2 times.
3. Inoculate 0.1 ml of virus suspension and serially diluted virus suspension in duplicate. As negative control, 0.1 ml of maintenance medium is inoculated.
4. Put the plate in CO2 incubator at 34 C and keep it for 1 h to let the cells absorb the virus. Tilt the plate every 15 min and let to absorb the virus to whole area of the cells.
5. Put 3 ml of maintenance medium in the plate and wash the surface, then drain extra maintenance medium.
6. Add 3 ml of agar medium for the plaque assay. Close the lid and keep at room temperature for 10 min.
7. Confirm the agar solidified, invert the plate upside down, put it in CO2 incubator at 34 C and keep it for 2-3 days to culture. After taking it out from CO2 incubator, put it upright, add 3 ml of the formalin solution for cell fixation, and keep it at room temperature for more than 1 h to fix the cells.
8. Drain the agar medium, add 3 ml of the methylene blue solution, keep it at room temperature for 15 min to dye the cells.
9. Wash the extra methylene blue solution by tap water. Confirm the dyeing of the cells.
10. Count the number of plaques.

### E. Calculations:

Mean log₁₀ reduction=Mean of common logarithm of viral infectivity titer using PBS after 20 min contact time (PFU/fabric carrier)−Mean of common logarithm of viral infectivity titer using a test sample after 20 minutes contact time (PFU/fabric carrier) Mean Log₁₀ Reduction

### Example I

Inventive Compositions #1, #2, #3, and Comparative Compositions #4, #5, #6 are evaluated according to the Virucidal Test Method for Evaluating Antivirus Efficacy of Freshening Composition described hereinbefore under Test Methods. Table 2 below shows antivirus activity values of individual samples of fabric treated with Inventive Compositions 1, 2, 3 and Comparative Compositions 4, 5, 6 respectively.

TABLE 3
Antivirus Efficacy Log R on Virus type after 20
minutes based on Antivirus Efficacy Test Method

| | Inventive Composition | | | | | |
|---|---|---|---|---|---|---|
| | #1 | #2 | #3 | Comparative Composition | | |
| | pH = 5 | pH = 4 | pH = 3 | #4 | #5 | #6 |
| non-enveloped | 3.71 | 3.69 | 3.6 | 1.71 | 0.32 | 0.13 |
| virus #1 Feline | | | | | | |
| calicivirus | | | | | | |
| (FCV) | | | | | | |
| non-enveloped | ≥4.63 | 3.72 | 1.04 | n/a | n/a | n/a |
| virus #2 | | | | | | |
| Rotavirus | | | | | | |
| enveloped | ≥4.08 | n/a | n/a | ≥4.79 | n/a | n/a |
| virus #3 | | | | | | |
| Influenza type | | | | | | |
| A virus | | | | | | |
| (H3N2) ATCC | | | | | | |
| VR-1679 | | | | | | |

Based on the above results, individual fabrics treated with each of Inventive Compositions 1, 2, 3 having a mixture of first and second antimicrobial agents and a pH from 3 to 5 have improved antivirus activity values relative to fabrics treated with Comparative Compositions 4, 5 and 6 having a pH of 6.75.

Without wish to be bound by theory, it is submitted that sodium citrate functions as a chelating agent to improve antivirus efficacy as shown in the above results in Example I. In particular, all inventive compositions having sodium citrate, a mixture of antimicrobial agents and a pH from 3 to 6 at room temperature exhibit an antivirus activity value of at least 1, at least 2, or at least 3, on at least one enveloped virus and at least one non-enveloped virus disposed on the inanimate surface. The enveloped virus may be selected from the group consisting of: Influenza type A virus (H3N2) ATCC VR-1679, and the non-enveloped virus may be selected from the group consisting of: Feline calicivirus (FCV), Rotavirus. In contrast, all the Comparative compositions 4, 5, 6 (without sodium citrate, and having a pH of 6.75) do not show improved antivirus activity value for at least one enveloped virus and at least one non-enveloped virus.

In particular, Inventive Composition 1 having a pH of 5 and sodium citrate in an amount of 0.3% by weight of the composition and a mixture of first and second antimicrobial agents in an amount of 0.24% by weight of the composition enables a higher antivirus activity value for two types of non-enveloped virus (Feline calicivirus (FCV), Rotavirus) and enveloped virus (Influenza type A virus (H3N2) ATCC VR-1679) relative to Comparative Composition 6 having the same mixture of first and second antimicrobial agents but without sodium citrate, and having a pH greater than 6, i.e. 6.75.

### Example II

Inventive Compositions #1, #2, #3, and Comparative Compositions #4, #5, #6 are evaluated according to the Test Method for Evaluating Antibacterial Efficacy of Freshening Composition described hereinbefore under Test Methods. Table 4 below shows antibacterial activity values of individual samples of fabric treated with Inventive Compositions 1, 2, 3 and Comparative Compositions 4, 5, 6 respectively.

TABLE 4
Antibacterial Efficacy Log R on Bacterium species # after
20 minutes based on Antibacterial Efficacy Test Method

| | Inventive Composition | | | Comparative Composition | | |
|---|---|---|---|---|---|---|
| | #1 | #2 | #3 | #4 | #5 | #6 |
| #1 S. aureus | 5.6 | 5.6 | 5.6 | ≥5.1 | n/a | n/a |
| ATCC 6538 | | | | | | |
| #2 P. mirabilis | 6.4 | 6.4 | 6.4 | ≥5.4 | n/a | 6.3 |
| ATCC 7002 | | | | | | |
| #3 E. coli | 6 | 6 | 6 | n/a | n/a | 4.5 |
| NBRC 3972 | | | | | | |
| #4 K. pneumoniae | 6.1 | 6.1 | 6.1 | n/a | n/a | 5.9 |
| NBRC 13277 | | | | | | |
| #5 E. hirae | 6.1 | 6.1 | 6.1 | n/a | n/a | n/a |
| ATCC 10541 | | | | | | |
| #6 P. aeruginosa | 5.5 | 5.5 | 5.4 | n/a | n/a | 0.91 |
| ATCC 15442 | | | | | | |
| #7 E. coli | 5.6 | 5.6 | 5.6 | n/a | n/a | 1.6 |
| ATCC 10536 | | | | | | |
| #8 E. aerogenes | 5.8 | 5.8 | 5.8 | n/a | n/a | 1.8 |
| ATCC 13048 | | | | | | |
| #9 S. enterica | 6.3 | 6.3 | 6.3 | n/a | n/a | 1.0 |
| ATCC 10708 | | | | | | |
| #10 K. pneumoniae | 6.1 | 6.1 | 6.1 | n/a | n/a | 6.1 |
| ATCC 4352 | | | | | | |

The above results of Inventive Compositions 1, 2, 3 show that an inventive freshening composition having a pH of 3 to 6 and comprising a mixture of antimicrobial agents in a level of 0.24% by weight of the composition demonstrate an antibacterial activity value of at least 2 on the test fabrics for all tested bacterium including S. aureus ATCC 6538, P. mirabilis ATCC 7002, E. coli NBRC 3972, K. pneumoniae NBRC 13277, E. hirae ATCC 10541, P. aeruginosa ATCC 15442, E. coli ATCC 10536, E. aerogenes ATCC 13048, S. enterica ATCC 10708, and K. pneumoniae ATCC 4352. Comparative Composition 6 (having a mixture of antimicrobial agents in a level of 0.24% by weight of the composition and a pH of 6.75 (greater than 6) and with no sodium citrate does not demonstrate an antibacterial activity value of at least 2 for all test bacterium described hereinbefore.

An example is shown below:

A. A no-rinse freshening composition for treating an inanimate surface or article, the freshening composition comprising;
a) at least 85% by weight of the freshening composition of water;
b) a carboxylic acid;
c) a salt of citric acid;
d) a mixture of first and second antimicrobial agents, wherein each of the first and second antimicrobial agents is according to Formula (I),

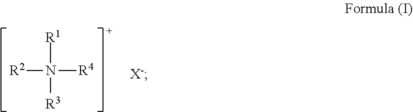

wherein
R¹ is a linear or branched C1 to C4 alkyl;
R² is a linear or branched C1 to C20 alkyl, benzyl or alkyl benzyl;
R³ is a linear or branched C6 to C20 alkyl, benzyl or alkyl benzyl;
R⁴ is a linear or branched C1 to C4 alkyl; and
X is an anion;
wherein the freshening composition comprises a neat pH of from 3 to 6 at room temperature;
wherein a weight ratio of the total amount of the carboxylic acid and the salt of citric acid to the mixture of the first and second antimicrobial agents is greater than 1:1, preferably from 1:1 to 10:1.

B. The composition according to Paragraph A, wherein the pH is from 3 to 5, preferably from 4 to 5.

C. The composition of any one of the preceding Paragraphs, wherein the carboxylic acid is selected from the group consisting of: dicarboxylic acid, polycarboxylic acid, tricarboxylic acid and combinations thereof, preferably the carboxylic acid is tricarboxylic acid, more preferably the tricarboxylic acid is selected from the group consisting of: citric acid, isocitric acid, aconitric acid and combinations thereof.

D. The composition of any one of the preceding Paragraphs, wherein the carboxylic acid is in an amount from 0.1% to 2.3% preferably from 0.15% to 2% by weight of the freshening composition.

E. The composition of any one of the preceding Paragraphs, wherein the salt of citric acid is selected from the group consisting of: sodium citrate, potassium citrate, aluminum citrate, diammonium citrate, ferric citrate, magnesium citrate, monosodium citrate, zinc citrate and mixtures thereof, preferably the salt of citric acid is sodium citrate.

F. The composition of any one of the preceding Paragraphs, wherein the salt of citric acid is in an amount of from 0.25% to 5%, preferably from 0.25% to 1% by weight of the freshening composition.

G. The composition of any one of the preceding Paragraphs, wherein the first antimicrobial agent or the second antimicrobial agent is selected from the group consisting of: alkyldimethylbenzyl ammonium chloride, dialkylmethylbenzyl ammonium chloride, dialkyldimethyl ammonium chloride, alkyldimethylethylbenzyl ammonium chloride, diisobutyl phenoxyethoxyethyl chloride, and blends thereof.

H. The composition of Paragraph G, wherein the dialkyldimethyl ammonium chloride is selected from the group consisting of dioctyldimethyl ammonium chloride, octyldecyldimethyl ammonium chloride, didecyldimethyl ammonium chloride, decylisononyldimethyl ammonium chloride, diisodecyldimethyl ammonium chloride, and blends thereof.

I. The composition of any one of the preceding Paragraphs, wherein the first and second antimicrobial agents are different quaternary ammonium compounds.

J. The composition of any one of the preceding Paragraphs, wherein one of the first and second antimicrobial agents is a blend of C8 to C12 dialkyl-quaternary ammonium compounds, preferably the blend is in an amount of less than 0.5%, preferably from 0.1% to 0.3%, even more preferably from 0.1% to 0.2% by weight of the freshening composition.

K. The composition of any one of the preceding Paragraphs, wherein each of the first and second antimicrobial agents is in an amount of less than 0.5%, preferably from 0.1% to 0.3%, more preferably from 0.1% to 0.2% by weight of the freshening composition.

L. The composition according to any of the preceding Paragraphs further comprising a malodor counteractant, wherein the malodor counteractant is selected from the group consisting of: polyols, cyclodextrin and derivatives thereof, amine functional polymers, aldehydes, and combinations thereof, preferably the malodor counteractant is cyclodextrin.

M. The composition according to any one of the preceding Paragraphs, wherein the inanimate surface or article is selected from the group consisting of: a permeable soft surface, a permeable hard surface, and mixtures thereof.

N. The composition according to Paragraph M, wherein the permeable soft surface is selected from the group consisting of: fabrics, drywall, wovens, natural polymers, synthetic polymers, inorganic materials and mixtures thereof.

O. The composition according to Paragraph M, wherein the permeable hard surface is selected from the group consisting of: finished laminate and wood, unfinished wood, painted wood, plastics and mixtures thereof.

P. The composition according to any one of the preceding Paragraphs, wherein the composition comprises an antivirus activity value of at least 1, preferably at least 2, more preferably at least 3, on at least one enveloped virus and at least one non-enveloped virus disposed on the inanimate surface at the end of a time period of at least 20 minutes, preferably the enveloped virus is selected from the group consisting of: Influenza type A virus (H3N2) ATCC VR-1679, and the non-enveloped virus is selected from the group consisting of: Feline calicivirus (FCV), Rotavirus.

Q. The composition according to any one of the preceding Paragraphs, wherein the composition comprises an antibacterial activity value of at least 1, preferably at least 2, more preferably at least 3, on at least one bacterium disposed on the inanimate surface at the end of a time period of at least 20 minutes, preferably the bacterium is selected from the group consisting: S. aureus ATCC 6538, P. mirabilis ATCC 7002, E. coli NBRC 3972, K. pneumoniae NBRC 13277, E. hirae ATCC 10541, P. aeruginosa ATCC 15442, E. coli ATCC 10536, E. aerogenes ATCC 13048, S. enterica ATCC 10708, K. pneumoniae ATCC 4352.

R. A product comprising the freshening composition according to any one of the preceding Paragraphs, wherein the freshening composition is provided in a product form selected from the group consisting of: a refillable package, a spray package, a packaging container, and a wipe.

S. A method of demonstrating efficacy of a no-rinse antimicrobial freshening composition for reducing virus activity and bacteria activity on an inanimate surface, the method comprising:
a) providing a freshening composition according to any one of Paragraphs A to Q; and
b) treating at least a portion of an inanimate surface having at least one virus and at least one bacterium disposed on the inanimate surface with the freshening composition for at least 20 minutes.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A no-rinse freshening composition for treating an inanimate surface or article, the freshening composition comprising:
a) at least 85% by weight of the freshening composition of water;
b) a carboxylic acid;
c) a salt of citric acid;
d) a mixture of first and second antimicrobial agents, wherein each of the first and second antimicrobial agents is according to Formula (I), 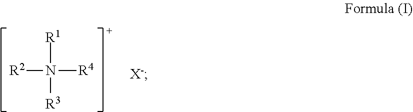
wherein
R¹ is a linear or branched C1 to C4 alkyl;
R² is a linear or branched C1 to C20 alkyl, benzyl or alkyl benzyl;
R³ is a linear or branched C6 to C20 alkyl, benzyl or alkyl benzyl;
R⁴ is a linear or branched C1 to C4 alkyl; and
X is an anion;
wherein the freshening composition comprises a neat pH of from 3 to 6 at room temperature; wherein a weight ratio of the total amount of the carboxylic acid and the salt of citric acid to the mixture of the first and second antimicrobial agents is from 1:1 to 10:1.

2. The composition according to claim 1, wherein the pH is from 3 to 5.

3. The composition of claim 1, wherein the carboxylic acid is selected from the group consisting of: dicarboxylic acid, polycarboxylic acid, tricarboxylic acid and combinations thereof.

4. The composition of claim 1, wherein the carboxylic acid is in an amount from 0.1% to 2.3% by weight of the freshening composition.

5. The composition of claim 1, wherein the salt of citric acid is selected from the group consisting of: sodium citrate, potassium citrate, aluminum citrate, diammonium citrate, ferric citrate, magnesium citrate, monosodium citrate, zinc citrate and mixtures thereof.

6. The composition claim 1, wherein the salt of citric acid is in an amount of from 0.25% to 5% by weight of the freshening composition.

7. The composition of claim 1, wherein the first antimicrobial agent or the second antimicrobial agent is selected from the group consisting of: alkyldimethylbenzyl ammonium chloride, dialkylmethylbenzyl ammonium chloride, dialkyldimethyl ammonium chloride, alkyldimethylethylbenzyl ammonium chloride, diisobutyl phenoxyethoxyethyl chloride, and blends thereof.

8. The composition of claim 7, wherein the dialkyldimethyl ammonium chloride is selected from the group consisting of dioctyldimethyl ammonium chloride, octyldecyldimethyl ammonium chloride, didecyldimethyl ammonium chloride, decylisononyldimethyl ammonium chloride, diisodecyldimethyl ammonium chloride, and blends thereof.

9. The composition of claim 1, wherein the first and second antimicrobial agents are different quaternary ammonium compounds.

10. The composition of claim 1, wherein one of the first and second antimicrobial agents is a blend of C8 to C12 dialkyl-quaternary ammonium compounds present in an amount of less than 0.5% by weight of the freshening composition.

11. The composition of claim 1, wherein each of the first and second antimicrobial agents is in an amount of less than 0.5% by weight of the freshening composition.

12. The composition according to claim 1 further comprising a malodor counteractant, wherein the malodor counteractant is selected from the group consisting of: polyols, cyclodextrin and derivatives thereof, amine functional polymers, aldehydes, and combinations thereof.

13. The composition according to claim 1, wherein the inanimate surface or article is selected from the group consisting of: a permeable soft surface, a permeable hard surface, and mixtures thereof.

14. The composition according to claim 13, wherein the permeable soft surface is selected from the group consisting of: fabrics, drywall, wovens, natural polymers, synthetic polymers, inorganic materials and mixtures thereof.

15. The composition according to claim 13, wherein the permeable hard surface is selected from the group consisting of: finished laminate and wood, unfinished wood, painted wood, plastics and mixtures thereof.

16. The composition according to claim 1, wherein the composition comprises an antivirus activity value of at least 1 on at least one enveloped virus and at least one non-enveloped virus disposed on the inanimate surface at the end of a time period of at least 20 minutes, wherein the enveloped virus is selected from the group consisting of: Influenza type A virus (H3N2) ATCC VR-1679, and the non-enveloped virus is selected from the group consisting of: Feline calicivirus (FCV), Rotavirus.

17. The composition according to claim 1, wherein the composition comprises an antibacterial activity value of at least 1 on at least one bacterium disposed on the inanimate surface at the end of a time period of at least 20 minutes, wherein the bacterium is selected from the group consisting: S. aureus ATCC 6538, P. mirabilis ATCC 7002, E. coli NBRC 3972, K. pneumoniae NBRC 13277, E. hirae ATCC 10541, P. aeruginosa ATCC 15442, E. coli ATCC 10536, E. aerogenes ATCC 13048, S. enterica ATCC 10708, K. pneumoniae ATCC 4352.

18. A product comprising the freshening composition according to claim 1, wherein the freshening composition is provided in a product form selected from the group consisting of: a refillable package, a spray package, a packaging container, and a wipe.

19. A method of demonstrating efficacy of a no-rinse antimicrobial freshening composition for reducing virus activity and bacteria activity on an inanimate surface, the method comprising:
a) providing a freshening composition according to claim 1; and
b) treating at least a portion of an inanimate surface having at least one virus and at least one bacterium disposed on the inanimate surface with the freshening composition for at least 20 minutes.
